(19) United States
(12) Patent Application Publication
(10) Pub. No.: US 2020/0363589 A1
(43) Pub. Date: Nov. 19, 2020

(54) RING RESONATOR FILTER AND METHOD FOR DESIGNING SAME

(71) Applicant: FURUKAWA ELECTRIC CO., LTD., Tokyo (JP)

(72) Inventors: Shintaro YAMASAKI, Tokyo (JP); Junichi HASEGAWA, Tokyo (JP)

(73) Assignee: FURUKAWA ELECTRIC CO., LTD., Tokyo (JP)

(21) Appl. No.: 16/944,272

(22) Filed: Jul. 31, 2020

Related U.S. Application Data
(63) Continuation of application No. PCT/JP2019/005328, filed on Feb. 14, 2019.

(30) Foreign Application Priority Data
Feb. 14, 2018 (JP) 2018-024397

(51) Int. Cl. G02B 6/293; G02B 6/02; G02B 6/125

(52) U.S. Cl. CPC G02B 6/293; G02B 2006/12147; G02B 6/125; G02B 6/02033

(57) ABSTRACT

A ring resonator filter, that is formed of a silica-based planar lightwave circuit, includes a core and a clad, the core including two arm units, a ring-like unit, and two optical coupling/branching units that optically couple the two arm units with the ring-like unit, and the optical coupling/branching units having a branch ratio that is either larger than 0% and less than 50% or larger than 50% and less than 100%.

### CROSS-REFERENCE TO RELATED APPLICATION(S)

This application is a continuation of International Application No. PCT/JP2019/005328, filed on Feb. 14, 2019 which claims the benefit of priority of the prior Japanese Patent Application No. 2018-024397, filed on Feb. 14, 2018, the entire contents of which are incorporated herein by reference.

### BACKGROUND

The present disclosure relates to a ring resonator filter and a method for designing the same.

As an optical device using a ring resonator, a device having a configuration where an optical coupling/branching device with a branch ratio of 50 to 50 is coupled to a ring resonator is disclosed (Japanese Laid-open Patent Publication No. 2000-231063).

As a method for controlling the wavelength of laser light output from a semiconductor laser device, there is a method for transmitting a part of the laser light through an etalon filter having transmission characteristics in a frequency-dependent periodic curve line relative to the wavelength of the light and monitoring the intensity of this transmitted light (Japanese Laid-open Patent Publication No. 2012-33895). This kind of mechanism is referred to as, for example, a wavelength locker. This etalon filter provides a wavelength discrimination curve with a transmission spectrum thereof.

### SUMMARY

There is a need for providing a ring resonator filter and a method for designing the same, having a high degree of design freedom of transmission characteristics. [0007]

According to an embodiment, a ring resonator filter, that is formed of a silica-based planar lightwave circuit, includes a core and a clad, the core including two arm units, a ring-like unit, and two optical coupling/branching units that optically couple the two arm units with the ring-like unit, and the optical coupling/branching units having a branch ratio that is either larger than 0% and less than 50% or larger than 50% and less than 100%.

### BRIEF DESCRIPTION OF THE DRAWINGS

FIG. 1 is a schematic diagram illustrating a ring resonator filter according to a first embodiment;

FIG. 2 is a view illustrating an example of transmission characteristics of the ring resonator filter in FIG. 1;

FIG. 3 is a view illustrating a structural optimization shape of an optical coupling/branching unit;

FIG. 4 is a schematic diagram illustrating a ring resonator filter according to a second embodiment;

FIG. 5 is a schematic diagram illustrating a ring resonator filter according to a third embodiment;

FIG. 6 is a schematic diagram illustrating a ring resonator filter according to a fourth embodiment; and

FIG. 7 is a view illustrating transmission characteristics of the ring resonator filter in FIG. 6.

### DETAILED DESCRIPTION

In the related art, since etalon filters have a low degree of design freedom of characteristics of a transmission spectrum, the degree of freedom of a wavelength discrimination curve that the etalon filters can provide may be also low.

Embodiments will now be described below with reference to the accompanying drawings. It should be noted that the embodiments are not intended to limit the present disclosure. In the description of the drawings, like numerals are appropriately given to like or corresponding components. The drawings are schematically illustrated, and it should be noted that the dimensional relation between components, the ratio of components, and the like in the drawings may differ from those applied in practice. Among the drawings, there may be parts in which the mutual dimensional relation and the ratio differ.

### First Embodiment

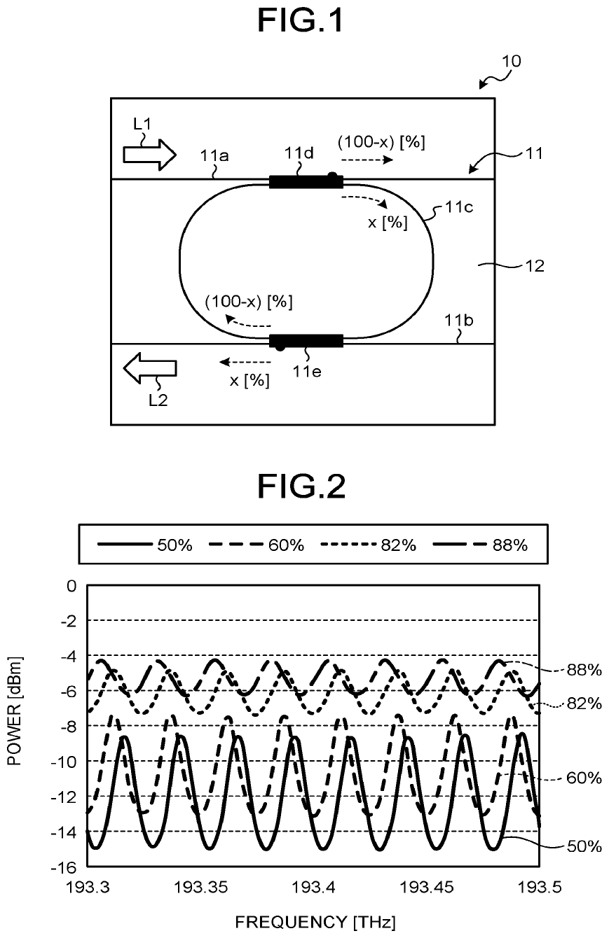

FIG. 1 is a schematic diagram illustrating a ring resonator filter according to a first embodiment. This ring resonator filter 10 is formed of a silica-based Planar Lightwave Circuit (PLC) that includes a core 11 and a clad 12.

The clad 12 surrounds the core 11, and is formed on, for example, a silicon substrate or a glass substrate. The clad 12 is formed of a silica-based glass material.

The core 11 is formed of a silica-based glass material having a refractive index higher than that of the clad 12. As the silica-based glass material having a high refractive index like this, for example, germanium (GeO₂) as a dopant for enhancing a refractive index and silica glass including zirconia (ZrO₂) can be used. Specifically, if what is called a SiO₂—ZrO₂-based material, which is silica glass including zirconia, is used, a relative refractive index of the core 11 to the clad 12 can be made higher to 5% or more. Thus, the SiO₂-—ZrO₂-based material is preferable to reduce the size of the ring resonator filter 10.

The core 11 includes two arm units 11a and 11b, a ring-like unit 11c, and two optical coupling/branching units 11d and 11e that optically couple the arm units 11a and 11b with the ring-like unit 11c. In the present embodiment, the arm units 11a and 11b are linear and the ring-like unit 11c has a rounded rectangle shape formed of two arc parts and two linear parts, but the shapes of the arm units 11a and 11b and the ring-like unit 11c are not limited to these. The ring-like unit 11c may have, for example, a round shape or an elliptical shape.

The optical coupling/branching units 11d and 11e are of the 2×2 type having two ports on the input side and two ports on the output side, and can be of the directional coupling type or the multi-mode optical interference (MMI) type. In the present embodiment, the optical coupling/branching units 11d and 11e are of the MMI type.

The sizes of the cross-sectional surfaces of the arm units 11a and 11b and the ring-like unit 11c are defined so that light of a use wavelength (for example, 1.55 μm band) can be propagated in a single mode depending on a relative refractive-index difference to the clad 12. The size of the cross-sectional surfaces of the optical coupling/branching units 11d and 11e is defined so that light of a use wavelength (for example, 1.55 μm band) can be propagated in a multi-mode depending on a relative refractive-index difference to the clad 12 and the branch ratio described below can be achieved.

The optical coupling/branching units 11d and lie are described more specifically. In the optical coupling/branching unit 11d, two ports on the input side are respectively connected to the arm unit 11a and the ring-like unit 11c, and also, two ports on the output side are respectively connected to the arm unit 11a and the ring-like unit 11c. In this manner, the optical coupling/branching unit 11d optically connects the arm unit 11a with the ring-like unit 11c. The optical coupling/branching unit 11d is arranged on one linear part of the ring-like unit 11c.

The optical coupling/branching unit 11d branches light L1 input from the left side of the arm unit 11a in FIG. 1 with the ratio of x to (100-x), and outputs x [%] of the light L1 to the ring-like unit 11c in the clockwise direction and outputs (100-x) [%] of the light L1 to the right side of the arm unit 11a in FIG. 1 as indicated by dashed arrows. In other words, the branch ratio of the optical coupling/branching unit 11d is x [%].

In the optical coupling/branching unit 11e, two ports on the input side are respectively connected to the arm unit 11b and the ring-like unit 11c, and also, two ports on the output side are respectively connected to the arm unit 11b and the ring-like unit 11c. In this manner, the optical coupling/branching unit 11e optically connects the arm unit 11b with the ring-like unit 11c. The optical coupling/branching unit 11e is arranged on the other linear part of the ring-like unit 11c. In other words, the optical coupling/branching units lid and 11e are arranged at positions facing each other across the center of the ring-like unit 11c. In other words, the optical coupling/branching units 11d and 11e are arranged point-symmetrically with respect to the center of the ring-like unit 11c, and are arranged axisymmetrically with respect to the long axis of the ring-like unit 11c.

The optical coupling/branching unit 11e branches light input from the ring-like unit 11c with the ratio of x to (100-x), and outputs (100-x) [%] of the light to the ring-like unit 11c in the clockwise direction and outputs x [%] of the light to the left side of the arm unit 11b in FIG. 1 as indicated by dashed arrows. In other words, the branch ratio of the optical coupling/branching unit 11e is x [%].

The branch ratio X [%] of the optical coupling/branching units 11d and 11e is defined as the one larger than 0% and less than 50% or the one larger than 50% and less than 100%. In the ring resonator filter 10, when the light L1 input from the left side of the arm unit 11a in FIG. 1 is defined as input light and light L2 output from the left side of the arm unit 11b in FIG. 1 is defined as transmission light, transmission characteristics of the ring resonator filter 10 vary depending on the branch ratio x [%].

FIG. 2 is a view illustrating an example of transmission characteristics of the ring resonator filter 10. A horizontal axis indicates the frequency of light, a vertical axis indicates the power of transmission light, and x of a spectrum is each defined as 50%, 60%, 82%, and 88%. As illustrated in FIG. 2, the spectrum of the power of transmission light varies depending on x. For example, if a difference between the maximum value and the minimum value of the power of transmission light is defined as an Extinction Ratio (ER) and the minimum value is specified as excessive loss, when x is 50%, 60%, 82%, and 88%, the ER is 7.1 dB, 5.5 dB, 2.5 dB, and 1.7 dB and the excessive loss is 7.6 dB, 6.7 dB, 4.8 dB, and 4.2 dB, respectively. When x is defined as 30%, the ER is, for example, 9.0 dB and the excessive loss is 10 dB.

In other words, the ring resonator filter 10 can freely change transmission characteristics thereof and have a high degree of design freedom of the transmission characteristics by changing the settings of the branch ratio x of the optical coupling/branching units 11d and 11e. Expressing in another way, the ring resonator filter 10 having desired transmission characteristics can be easily designed by defining the branch ratio of the optical coupling/branching units 11d and 11e depending on desired transmission characteristics.

If for example, this ring resonator filter 10 is applied to a wavelength locker by making use of a high degree of design freedom as mentioned above, depending on control of the wavelength of laser light required for specifications, a wavelength discrimination curve of the design suitable for the control can be provided. In addition, the ring resonator filter 10 can be applied to a variety of uses by making use of a high degree of design freedom regardless of the uses of a wavelength locker.

As known from FIG. 2, the larger the branch ratio x [%] is, the lower the excessive loss is. Thus, the branch ratio x [%] is preferably larger for reducing loss of light, and is preferably larger than, for example, 50%. More preferably, the branch ratio x [%] is 60% to 90%.

The optical coupling/branching units 11d and 11e preferably have a structural optimization shape that is specified by repeatedly calculating loss in shape where an outer shape is minutely perturbed. The structural optimization shape means a shape specified by computer simulation as a shape capable of reducing excessive loss by repeating a process of minutely perturbing the outer shape of the optical coupling/branching units 11d and 11e and calculating coupled loss in the perturbed shape through the computer simulation. This optimization algorithm can use methods known by the name of, for example, the wavefront-matching method and topological optimization method.

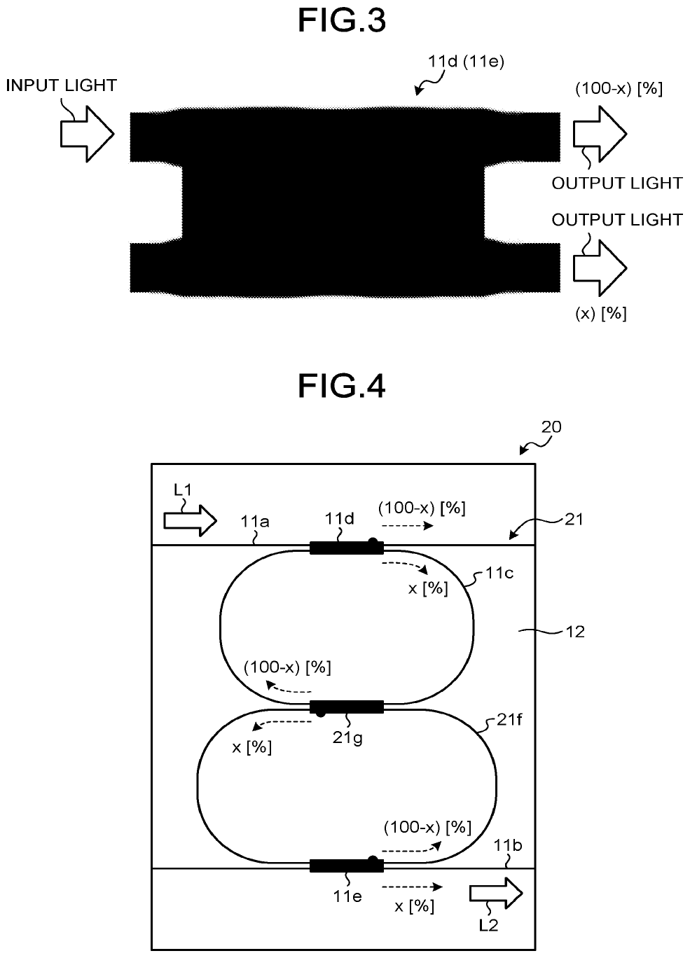

FIG. 3 is a view illustrating a structural optimization shape of the optical coupling/branching unit 11d and 11e. These optical coupling/branching units 11d and 11e are formed in a structural optimization shape using the topological optimization method, and the outer shape thereof is not linear but is minutely recessed and projected. By forming this kind of structural optimization shape, the excessive loss of the optical coupling/branching units 11d and 11e can be reduced. As illustrated in FIG. 3, input light is branched with the ratio of x to (100-x) and is output as output light.

### Second Embodiment

FIG. 4 is a schematic diagram illustrating a ring resonator filter according to a second embodiment. This ring resonator filter 20 is formed of a silica-based PLC that includes a core 21 and the clad 12. Because constitutional materials and the sizes of cross-sectional surfaces of the core 21 and the clad 12 are the same as those of the core 11 and the clad 12 in the ring resonator filter 10 according to the first embodiment, respectively, the explanation thereof is omitted.

The core 21 includes the two arm units 11a and lib, two ring-like units 11c and 21f, the optical coupling/branching unit 11d that optically couples the arm unit 11a with the ring-like unit 11c, the optical coupling/branching unit 11e that optically couples the arm unit 11b with the ring-like unit 21f, and an optical coupling/branching unit 21g that optically couples the ring-like unit 11c with a ring-like unit 11f. In other words, the ring resonator filter 20 has a configuration where the ring-like unit 21f and the optical coupling/branching unit 21g are added to the configuration of the ring resonator filter 10.

The ring-like unit 21f has an optical length different from that of the ring-like unit 11c, and has a Free Spectral Range (FSR) different from that of the ring-like unit 11c. In the present embodiment, the ring-like unit 21f has a rounded rectangle shape, but the shape thereof is not limited to this.

The optical coupling/branching unit 21g are of the 2×2 type having two ports on the input side and two ports on the output side, and can be of the directional coupling type or the MMI type. In the present embodiment, the optical coupling/branching unit 21g is of the MMI type. In addition, the optical coupling/branching unit 21g preferably has a structural optimization shape. As indicated by a dashed arrow, the branch ratio of the optical coupling/branching unit 21g is also x [%] in the same way as the optical coupling/branching units 11d and 11e. Furthermore, the optical coupling/branching units 11d and 21g are arranged at positions facing each other across the center of the ring-like unit 11c. The optical coupling/branching units 21g and 11e are arranged at positions facing each other across the center of the ring-like unit 21f.

In this ring resonator filter 20, when the light L1 input from the left side of the arm unit 11a in FIG. 4 is defined as input light and the light L2 output from the right side of the arm unit 11b in FIG. 4 is defined as transmission light, transmission characteristics of the ring resonator filter 20 include a transmission spectrum obtained by combining a transmission spectrum reflecting the FSR and the branch ratio x [%] of the ring-like unit 11c with a transmission spectrum reflecting the FSR and the branch ratio x [%] of the ring-like unit 21f.

In addition, transmission characteristics of the ring resonator filter 20 vary depending on the branch ratio x [%] in the same way as the ring resonator filter 10. Thus, the ring resonator filter 20 can freely change transmission characteristics thereof and have a high degree of design freedom of the transmission characteristics by changing the settings of the branch ratio x of the optical coupling/branching units 11d, 11e, and 21g. The ring resonator filter 20 having desired transmission characteristics can be easily designed by defining the branch ratio of the optical coupling/branching units 11d, 11e, and 21g depending on desired transmission characteristics.

### Third Embodiment

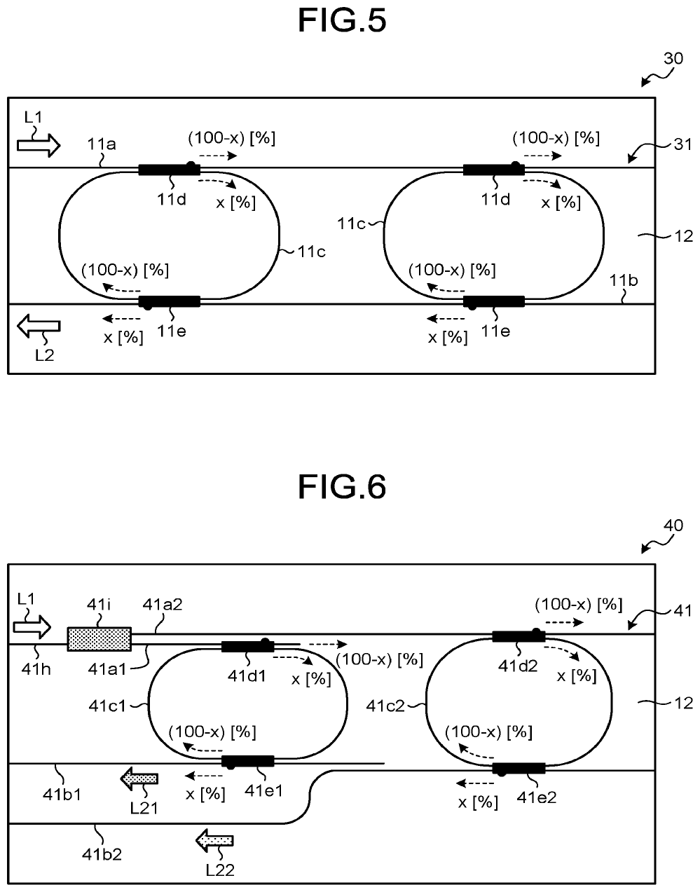

FIG. 5 is a schematic diagram illustrating a ring resonator filter according to a third embodiment. This ring resonator filter 30 is formed of a silica-based PLC that includes a core 31 and the clad 12. Because constitutional materials and the sizes of cross-sectional surfaces of the core 31 and the clad 12 are the same as those of the core 11 and the clad 12 in the ring resonator filter 10 according to the first embodiment, respectively, the explanation thereof is omitted.

The core 31 has a configuration where another set of the ring-like unit 11c and the optical coupling/branching unit 11d and 11e is added to the configuration of the core 21 in the ring resonator filter 10.

In this ring resonator filter 30, when the light L1 input from the left side of the arm unit 11a in FIG. 5 is defined as input light and the light L2 output from the left side of the arm unit 11b in FIG. 5 is defined as transmission light, transmission characteristics of the ring resonator filter 30 include a transmission spectrum obtained by combining transmission spectra reflecting the FSR and the branch ratio x [%] of the two ring-like units 11c and 11c. In this case, the two transmission spectra are combined in a state where phases are shifted by a phase difference corresponding to the optical length between the two optical coupling/branching units 11d.

Transmission characteristics of the ring resonator filter 30 vary depending on the branch ratio x [%] and the phase difference. Thus, the ring resonator filter 30 can freely change transmission characteristics thereof and have a high degree of design freedom of the transmission characteristics by changing the settings of the branch ratio x of the optical coupling/branching units 11d and 11e and the phase difference. The ring resonator filter 20 having desired transmission characteristics can be easily designed by defining the branch ratio of the optical coupling/branching units 11d and 11e and the phase difference depending on desired transmission characteristics.

### Fourth Embodiment

FIG. 6 is a schematic diagram illustrating a ring resonator filter according to a fourth embodiment. This ring resonator filter 40 is formed of a silica-based PLC that includes a core 41 and the clad 12. Because constitutional materials and the sizes of cross-sectional surfaces of the core 41 and the clad 12 are the same as those of the core 11 and the clad 12 in the ring resonator filter 10 according to the first embodiment, respectively, the explanation thereof is omitted.

The core 41 includes an input unit 41h, a delay unit 41i, arm units 41a1, 41a2, 41b1, and 41b2, ring-like units 41c1 and 41c2, optical coupling/branching units 41d 1 and 41e1 that optically couple the arm units 41a1 and 41b1 with the ring-like unit 41c1, and optical coupling/branching units 41d2 and 41e2 that optically couple the arm units 41a2 and 41b2 with the ring-like unit 41c2.

The delay unit 41i branches the light L1 input from the input unit 41h into two parts, and outputs the branched light L1 to the arm units 41a1 and, 41a2. In this case, a time delay is given to at least one of the two beams of light output to the arm units 41a1 and 41a2 so as to make a phase difference between the two beams of light. This phase difference is defined as, for example, π/2.

The arm units 41a1 and 41b1, the ring-like unit 41c1, and the optical coupling/branching units 41d 1 and 41e1 correspond to the arm units 11a and 11b, the ring-like unit 11c, and the optical coupling/branching units 11d and 11e in the ring resonator filter 10, respectively. In the same way, the arm units 41a2 and 41b2, the ring-like unit 41c2, and the optical coupling/branching units 41d2 and 41e2 correspond to the arm units 11a and 11b, the ring-like unit 11c, and the optical coupling/branching units 11d and 11e, respectively.

The branch ratio X [%] of the optical coupling/branching units 41d 1, 41e1, 41d2, and 41e2 is defined as the one larger than 0% and less than 50% or the one larger than 50% and less than 100%. In the ring resonator filter 40, when the light L1 input from the input unit 41h is defined as input light and light L21 and light L22 output from the left side of the arm units 41b1 and 41b2 in FIG. 6 are defined as transmission light, transmission characteristics of the ring resonator filter 20 vary depending on the branch ratio x [%].

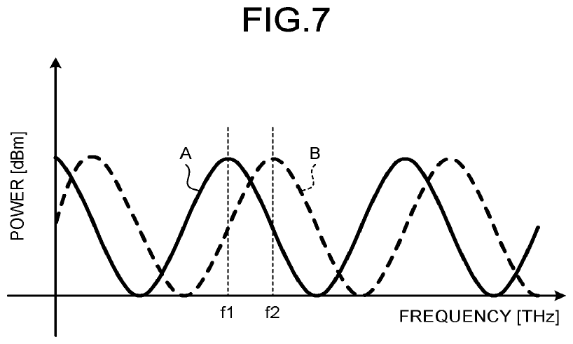

FIG. 7 is a view illustrating an example of transmission characteristics of the ring resonator filter 40. A spectrum A is the spectrum of the power of transmission light with respect to the light L21. A spectrum B is the spectrum of the power of transmission light with respect to the light L22. In this manner, the spectra A and B are spectra in which a phase difference is made by action of the delay unit 41i.

Upon application to a wavelength locker, when the frequency of laser light to be contro1 is f1, for example, the ring resonator filter 40 described above uses the spectrum B, which has a large inclination of a transmission rate to the frequency in the frequency f1, as a wavelength discrimination curve. By contrast, when the frequency is f2, the ring resonator filter 40 uses the spectrum A, which has a large inclination of a transmission rate to the frequency in the frequency f2, as a wavelength discrimination curve. In this manner, a more suitable wavelength discrimination curve can be provided depending on the frequency of laser light.

In the present embodiment, both the branch ratio of the optical coupling/branching units 41d 1 and 41e1 and the branch ratio of the optical coupling/branching units 41d2 and 41e2 are the same X [%], but the branch ratio of the optical coupling/branching units 41d 1 and 41e1 and the branch ratio of the optical coupling/branching units 41d2 and 41e2 may have values that are different from each other.

In each of the embodiments described above, the number of ring-like units is 1 or 2, but may be 3 or more depending on a use application and the like. In addition, in each of the embodiments described above, two optical coupling/branching units are arranged point-symmetrically with respect to the center of a ring-like unit and are arranged axisymmetrically with respect to the long axis of the ring-like unit, but effects of the present disclosure are achieved even when arrangement of the two optical coupling/branching units is formed of any one of the point-symmetrical arrangement and the axisymmetrical arrangement. If a ring-like unit has a round shape, a symmetrical axis for arranging optical coupling/branching units axisymmetrically is any axis passing through the center.

The present disclosure achieves an effect of implementing a ring resonator filter that has a high degree of design freedom of transmission characteristics.

The present disclosure may adequately be applied to a ring resonator filter that has a high degree of design freedom of transmission characteristics and a method of designing the same.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A ring resonator filter that is formed of a silica-based planar lightwave circuit that comprises a core and a clad, wherein
the core includes two arm units, a ring-like unit, and two optical coupling/branching units that optically couple the two arm units with the ring-like unit, and
the optical coupling/branching units have a branch ratio that is either larger than 0% and less than 50% or larger than 50% and less than 100%.

2. The ring resonator filter according to claim 1, wherein the optical coupling/branching units have the branch ratio that is larger than 50%.

3. The ring resonator filter according to claim 1, wherein the core includes a plurality of the ring-like units.

4. The ring resonator filter according to claim 3, wherein the core further includes an optical coupling/branching unit that optically couples the ring-like units.

5. The ring resonator filter according to claim 1, wherein the optical coupling/branching units are of a multi-mode optical interference type.

6. The ring resonator filter according to claim 1, wherein the optical coupling/branching units have a structural optimization shape that is specified by repeatedly calculating loss in shape where an outer shape is minutely perturbed.

7. The ring resonator filter according to claim 1, wherein a relative refractive-index difference of the core to the clad is 5% or more.

8. A method for designing a ring resonator filter that is formed of a silica-based planar lightwave circuit that comprises a core and a clad, the core including two arm units, a ring-like unit, and two optical coupling/branching units that optically couple the two arm units with the ring-like unit, the method comprising:
defining the branch ratio of the optical coupling/branching units depending on desirable transmission characteristics.
